(19) United States
(12) Patent Application Publication
(10) Pub. No.: US 2005/0250640 A1
(43) Pub. Date: Nov. 10, 2005

(54) Sintered silicon carbide bodies with optimised tribological properties for the slide and sealing surfaces thereof

(76) Inventors: Gerd Meier, Leinburg (DE); Jurgen Bottcher, Bekental-Eschen (DE); Konstantin Elterlein, Neunkirchen (DE); Matthias Steiner, Tothenbach (DE); Dieter Kafer, Pettensiedel (DE); Matthias Simmerl, Henfenfeld (DE)

Correspondence Address: FULBRIGHT & JAWORSKI, LLP, 666 FIFTH AVE, NEW YORK, NY, 10103-3198, US

(21) Appl. No.: 10/525,131

(22) PCT Filed: Sep. 2, 2003
(86) PCT No.: PCT/EP03/09748

§ 371 Date: Apr. 14, 2005

(30) Foreign Application Priority Data
Sep. 6, 2002 (DE) 102 41 265.0

(51) Int. Cl. C04B 35/565; C04B 38/06

(52) U.S. Cl. 501/81; 501/88

(57) ABSTRACT

The material silicon carbide possesses not just extraordinarily good thermal, chemical and mechanical properties, as a result of an adjustable porosity it is also possible to apply the material in conditions with difficult tribological relationships. As the porosity influences not only the friction between two workpieces, but also the rigidity of a material, a careful selection of pore diameter, number of pores per unit volume of material and the distribution of the pores in the material is necessary. According to the invention, with a porosity of the sintered silicon carbide body of 2 to 12 vol. %, comprised of non-communicating closed pores, evenly distributed in the material, the pores are spherical and have a nominal diameter of from 10 μm to 48 μm.

The invention relates to sintered silicon carbide bodies with a defined porosity and, as a result, optimum tribological properties of their sliding and/or sealing surfaces.

The material silicon carbide not only has exceptionally good thermal, chemical and mechanical properties. Because of its adjustable porosity, it is additionally possible to use the material where difficult tribological conditions prevail. Especially where, owing to a lack of lubricant, there is a risk of dry friction occurring between two sliding surfaces moving against one another, the open pores at the surface act as a lubricant reservoir. This property is exploited e.g. in sliding and sealing rings.

Since the porosity affects not only the friction between two workpieces but also the strength of a material, careful selection of the pore diameters, the number of pores per unit volume of the material and the distribution of the pores in the material is necessary. The pores must not be so big that they weaken the material, and their number must not lead to the pores being interconnected and leading to sponge-like structures. This would result, for example, in a loss of function in sealing rings. On the other hand, the pores must not be so small that the liquid medium intended to act as lubricant fails to penetrate into the pores owing to its surface tension and does not fill them or does not come out of the pores.

From European patent EP 0 578 408 B1, a silicon carbide sintered body is known with a porosity in the range of 2 to 12 vol. %, wherein the free pores have a nominal diameter of between 50 and 500 μm, the pores are closed and the pores are uniformly distributed within the body.

In the European patent application EP 0 578 408 A2, the same features are claimed with the sole difference that the shape of the pores should be spherical.

From European patent EP 0 486 336 B1, a silicon-carbide-based sintered body is known, which is free from impregnated silicon and which has substantially closed pores in an approximately spherical shape with an average diameter of between 60 and 200 μm and a true porosity of between 4 and 18%.

The object of the present invention is to present sintered bodies made of silicon carbide which, owing to the proportion of pores with a defined nominal diameter, can be optimally adapted to the prevailing tribological conditions.

The object is achieved according to the invention with the aid of the characterising features of the first claim. Advantageous embodiments of the invention are claimed in the dependent claims.

The sintered silicon carbide bodies according to the invention are characterised by a true porosity of 2 to 12 vol. % and spherical pores with a nominal diameter of between 10 μm and 48 μm, the pores being uniformly distributed in the material of the sintered body. The spherical pores preferably have a nominal diameter of 15 μm to 45 μm.

A narrow range of pore diameters is chosen deliberately since, as a result, open pores with apertures not exceeding the maximum nominal pore diameter and uniformly distributed over the surface are formed on the sliding surface of the sintered bodies, which obtains the required surface quality by a surface treatment, e.g. by grinding, lapping or polishing. These pores create lubricant reservoirs distributed very uniformly on the sliding surface, which enable the lubricant to be distributed homogeneously on the sliding surface for emergency running. As a result, uniform emergency running properties are guaranteed at every position on the sliding surface.

The narrow restriction of the pore diameter range, the distribution of the pore sizes over the total quantity of the pores and the porosity are advantageously determined by the choice and quantity of the pore-forming agents. If, for example, a diameter range of the spherical pores of 30 μm to 48 μm is desired, pore-forming agents with a minimum particle diameter of 36 μm and a maximum particle diameter of 57 μm should be used if a technical allowance of the workpiece of 20% is assumed, which takes into account the linear ceramic shrinkage of 16.7%. The technical allowance is defined as follows: the dimension after sintering is subtracted from the dimension before sintering. The difference is divided by the dimension after sintering. The result is the technical allowance. The ceramic shrinkage is defined as follows: the dimension after sintering is subtracted from the dimension before sintering. The difference is divided by the dimension before sintering. The result is the ceramic shrinkage.

To produce the desired pore sizes, the pore-forming agents must be prepared appropriately, e.g. by dry or wet sieving, taking into account the shrinkage on sintering of the silicon carbide bodies. The desired starting particle sizes can be produced in advance for the inorganic raw materials by means of grinding processes known from the prior art.

Only substances that can be removed from the material of the component in such a way that the spherical pores are formed in the desired diameter range are suitable as pore-forming agents. So-called ‘burnout’ materials are used as pore-forming agents, such as e.g. polymethyl methacrylate (PMMA), polyethylene (PE) or polystyrene (PS) among the polymers, paraffin waxes or polyethylene waxes among the waxes and natural products such as starch or cellulose.

The pore-forming agents are mixed with the inorganic, ceramic starting materials of the sintered bodies in a manner that is known per se. This generally takes place by suspending them in a suitable liquid medium, subsequently mixing with the inorganic starting substances, adding and homogenising the organic binders and then spray-drying (spray granulating). However, it is also possible to suspend them in a suspension consisting of a liquid medium with the binders already dissolved therein and the ceramic raw materials. The shaping generally takes place by compression moulding.

When selecting the pore-forming agents, it should be ensured that they are not destroyed or deformed by the action of force, e.g. on mixing with the inorganic ceramic slurry as a result of the shearing and grinding action. Equally, the pore-forming agents must not exhibit excessive elastic recovery during shaping by compression. This would lead to stress cracks in the pressed green body when pressure is released from the mouldings. A compaction of the pore-forming agents, combined with a slight deformation during the compression and compaction operation, can be tolerated.

If the ceramic starting substances are suspended in water, the pore-forming agents must be water-insoluble, or at least sparingly soluble in water. These properties are possessed e.g. by natural starches, which do not dissolve in cold water unless they have previously been subjected to a chemical or thermal treatment. Each type of starch, defined as maize, rice or wheat starch according to its origin, is characterised by a particular diameter of the spherical starch particles, and so the porosity and the pore diameter in the material of a sintered body can be adjusted as desired.

Following the shaping of the silicon carbide bodies as green bodies, which generally takes place by a compression process, both the organic binders and the pore-forming agents introduced as place holders for the pores are completely, or at least almost completely, removed from the material of the pressed body in a heat treatment, pyrolysis, which precedes the sintering process. The pore-forming agents used according to the invention decompose completely and leave behind, if anything, only small quantities of carbon as a decomposition residue. These carbon residues have no negative effect on the composition and the properties of the material during the subsequent sintering, however. The sintering of the pressed bodies pretreated in this way takes place in the same way as the sintering of silicon carbide mouldings without pore formation, as known from the prior art.

After sintering, the functional surfaces are machined by processes known from the prior art, such as grinding, lapping and polishing, this machining preferably taking place with diamond powder or diamond tools. It is not necessary to apply all three processes, depending on the requirements profile. Individual machining processes or a combination of two processes, e.g. only grinding or lapping, or grinding and polishing or grinding and lapping, may also suffice. After these machining processes, the surface must be carefully cleaned to free the pores and remove any material eroded from the surface that may have penetrated. This can take place e.g. by cleaning in ultrasonic baths.

The invention will be explained in more detail on the basis of four examples. The figures show the following:

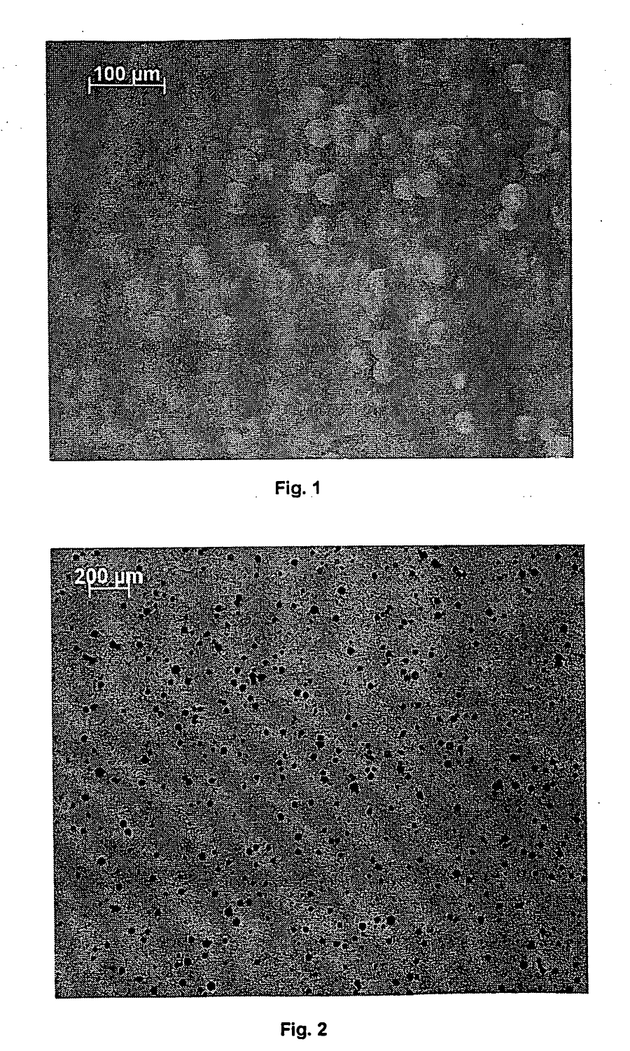

FIG. 1: photograph of the pore-forming agent polymethyl methacrylate (PMMA), photomicrograph,

FIG. 2: a photomicrograph of a grinding pattern of the surface of an example with a porosity of 4.77%,

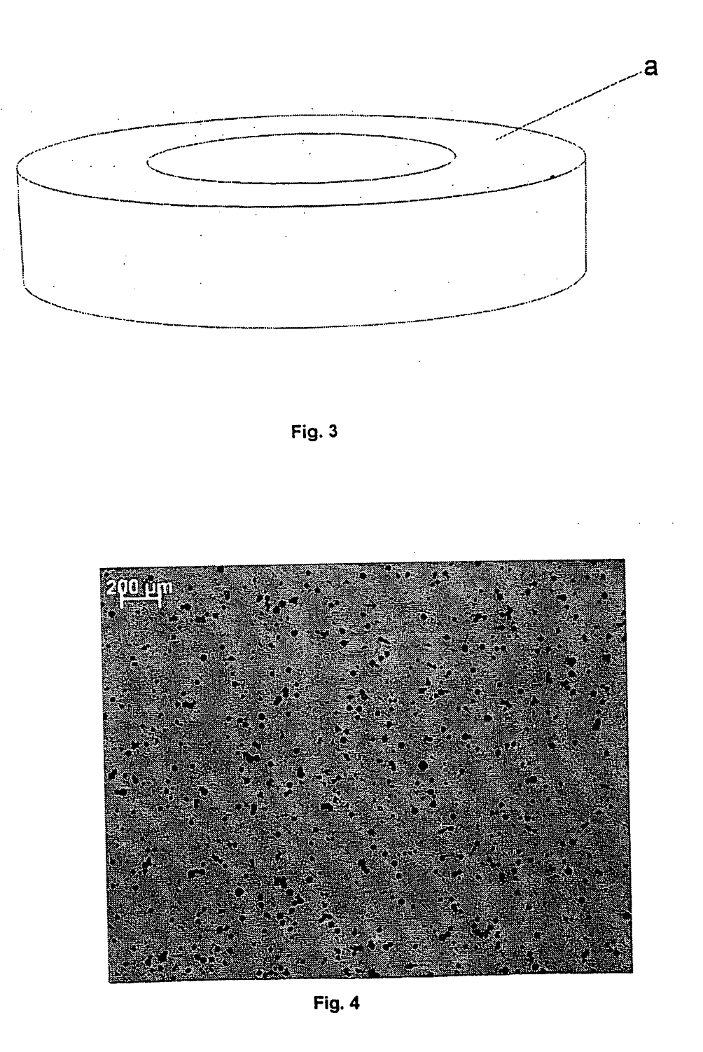

FIG. 3: a sealing ring according to the invention,

FIG. 4: a photomicrograph of a grinding pattern of the surface of an example with a porosity of 6.04%,

FIG. 5: a photomicrograph of a grinding pattern of the surface of an example with a porosity of 3.77% and

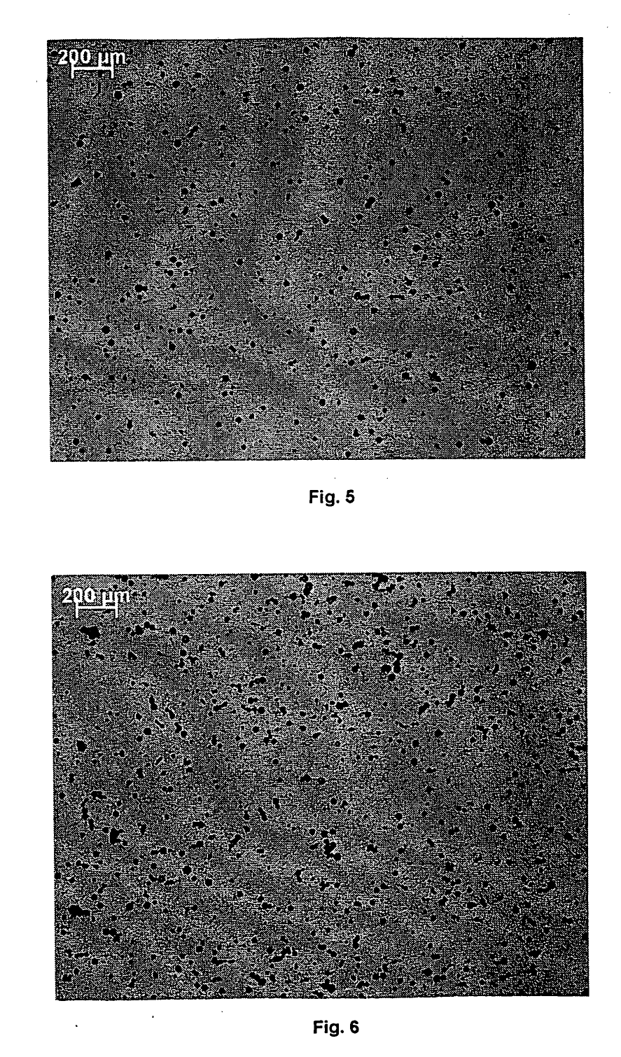

FIG. 6: a photomicrograph of a grinding pattern of the surface of an example with a porosity of 7.69%.

The inorganic, ceramic material is made up of the following components: alpha-silicon carbide (SiC), zirconium diboride (ZrB₂), carbon (C) and boron (B). To produce the green bodies, dispersants and binders, such as e.g. wax binders, polyethylene glycol binders and acrylate binders, are used.

To produce the pores, polymethyl methacrylate (PMMA) is added in the following examples. FIG. 1 shows a photomicrograph of the pore-forming agent PMMA. The ideal, spherical shape of the particles is clearly visible. Their diameter is in the range of about 18 μm to about 57 μm, the proportion of particles with diameters of between 20 μm and 45 μm being about 80% of the total quantity.

As a result of the reduction in the particle size due to the linear ceramic sintering shrinkage of 16.7%, the minimum possible nominal diameter of the pores is about 15 μm, the maximum about 48 μm and the average about 30 μm.

### EXAMPLE 1

Total composition to 100%:

| Inorganic materials: | |
|---|---|
| Alpha-silicon carbide (SiC) | 77.70% |
| Zirconium diboride (ZrB₂) | 9.22% |
| Carbon (C) | 2.98% |
| Boron (B) | 0.45% |

| Organic components | |
|---|---|
| (binders, dispersant): | |
| Dispersant | 2.14% |
| Wax binder | 1.81% |
| Polyethylene glycol binder | 1.81% |
| Acrylate binder | 1.81% |

| Pore-forming agent: | |
|---|---|
| Polymethyl methacrylate (PMMA) | 2.08% |

The homogenised, pre-ground, inorganic raw materials according to the total composition given above were dispersed in water with the dispersant dissolved therein and the organic components for about 30 min, after which the pore-forming agent PMMA was added, which was in turn dispersed for 30 min. After the addition and homogenisation of the organic binders, the suspension was spray-dried to obtain spray granules capable of compression.

The spray granules were compressed monoaxially into complete cylinders with a diameter of 20 mm and a height of 8 mm. The complete cylinders were sintered under a protective gas atmosphere for 120 min at a temperature of 2070° C. A true porosity of 4.77% was found by density determination. FIG. 2 shows the distribution of the pores on the ground and polished surface.

The size of the pores introduced in a defined manner is determined from the particle size distribution of the pore-forming agent introduced (FIG. 1) by reducing the particle sizes by the ceramic shrinkage of 16.7%, as explained above.

For Examples 2 to 4, differing from Example 1, the inorganic and organic components were mixed together as in Example 1 and then spray granules capable of compression were produced. The dry pore-forming agent PMMA was introduced into the granular mass and the dispersion was performed under dry conditions.

The material composition of Examples 2 to 4 differs slightly from that of Example 1.

### EXAMPLE 2

Total composition to 100%:

| Inorganic materials: | |
|---|---|
| Alpha-silicon carbide (SiC) | 77.18% |
| Zirconium diboride (ZrB₂) | 9.15% |
| Carbon (C) | 2.96% |
| Boron (B) | 0.45% |

| Organic components | |
|---|---|
| (binders, dispersant): | |
| Dispersant | 2.16% |
| Wax binder | 1.79% |
| Polyethylene glycol binder | 1.79% |
| Acrylate binder | 1.79% |

| Pore-forming agent: | |
|---|---|
| Polymethyl methacrylate (PMMA) | 2.73% |

Spray granules with the material composition given above were dry-mixed with the pore-forming agent PMMA in the particle size given, in the following quantitative ratio: spray granules 97.27% and PMMA: 2.73%.

This mixture was compressed monoaxially into sliding rings according to the diagram in FIG. 3 and sintered under a protective gas atmosphere for 120 min at a temperature of 2070° C. A true porosity of 6.04% was found by density determination. The nominal diameter of the pores is in the same range as in Example 1. FIG. 4 shows the distribution of the pores on the ground surface of the sintered rings, labelled as ‘a’ in FIG. 3.

### EXAMPLE 3

Total composition to 100%:

| Inorganic materials: | |
|---|---|
| Alpha-silicon carbide (SiC) | 77.94% |
| Zirconium diboride (ZrB₂) | 9.24% |
| Carbon (C) | 2.99% |
| Boron (B) | 0.45% |

| Organic components | |
|---|---|
| (binders, dispersant): | |
| Dispersant | 2.17% |
| Wax binder | 1.81% |
| Polyethylene glycol binder | 1.81% |
| Acrylate binder | 1.81% |

| Pore-forming agent: | |
|---|---|
| Polymethyl methacrylate (PMMA) | 1.78% |

Sliding rings with a lower true porosity were produced by the process described in Example 2. The composition was as follows: spray granules: 98.22% and PMMA: 1.78%. The true porosity of the sintered rings is 3.77%. The nominal diameter of the pores is in the same range as in Example 1. FIG. 5 shows the distribution of the pores on the ground surface of the sintered rings.

### EXAMPLE 4

Total composition to 100%:

| Inorganic materials: | |
|---|---|
| Alpha-silicon carbide (SiC) | 76.47% |
| Zirconium diboride (ZrB₂) | 9.07% |
| Carbon (C) | 2.93% |
| Boron (B) | 0.44% |

| Organic components (binders, dispersant): | |
|---|---|
| Dispersant | 2.12% |
| Wax binder | 1.78% |
| Polyethylene glycol binder | 1.78% |
| Acrylate binder | 1.78% |

| Pore-forming agent: | |
|---|---|
| Polymethyl methacrylate (PMMA) | 3.63% |

Sliding rings with a higher true porosity were produced by the process described in Example 2. The composition was as follows: spray granules: 96.37% and PMMA: 3.63%. The true porosity of the sintered rings is 7.69%. The nominal diameter of the pores is in the same range as in Example 1. FIG. 6 shows the distribution of the pores on the ground surface of the sintered rings.

1-13. (canceled)

14. A sintered silicon carbide body having a porosity of 2 to 12 vol. %, wherein the porosity comprises unconnected, closed pores, which are uniformly distributed in the material of the bodies, wherein the pores are spherical, wherein the pores have a nominal diameter of 10 μm to 48 μm and that the diameter of the particles of the pore-forming agent for the production of the pores is in the range of 18 μm to 57 μm before the compaction of a green body to form the silicon carbide body.

15. A sintered silicon carbide body according to claim 14, wherein the pores have a nominal diameter of 15 μm to 45 μm.

16. A sintered silicon carbide body according to claim 14, wherein the inorganic component of the material contains 80% to 98% silicon carbide, 0.5% to 5% carbon, 0.3% to 5% boron and 0% to 20% of a hard material selected from the group consisting of a boride and a silicide.

17. A sintered silicon carbide body according to claim 14, wherein the inorganic component of the material contains 85% to 98% silicon carbide, 1.5% to 4% carbon, 0.5% to 2% boron and 0% to 12% of a hard material.

18. A sintered silicon carbide body according to claim 14, wherein the silicon carbide is alpha-silicon carbide.

19. A sintered silicon carbide body according to claim 14, wherein burnout materials, such as polymers, waxes, starches or cellulose, are used as pore-forming agents.

20. A sintered silicon carbide body according to claim 19, wherein polymethyl methacrylate (PMMA) is used as pore-forming agent.

21. A sintered silicon carbide body according to claim 20, wherein the pore-forming agent is added in a quantity of 0.70 to 5.40 wt. %.

22. A sintered silicon carbide body according to claim 14, wherein the proportion of particles of the pore-forming agent with nominal diameters of between 30 μm and 45 μm is 80% of the total quantity.

23. A process for the production of a sintered silicon carbide body comprising dispersing a pore-forming agent in a suspension of inorganic raw materials components of the material, shaping the body, and heat treating by pyrolysis and sintering to form the sintered silicon carbide body.

24. A process for the production of a sintered silicon carbide body, comprising dispersing pore-forming agent in a suspension of inorganic and organic raw material components of the material, shaping and heating by pyrolysis and sintering to form the sintered silicon carbide body.

25. A process for the production of a sintered silicon carbide body comprising drying a suspension of inorganic and organic raw material components of the materials and homogenously mixing the pore-forming agent in the dry state with the mixed inorganic and organic components shaping, and heating to produce the sintered body by pyrolysis and sintering.
